(19) United States
(12) Patent Application Publication
(10) Pub. No.: US 2013/0246726 A1
(43) Pub. Date: Sep. 19, 2013

(54) METHOD AND DEVICE FOR A MEMORY SYSTEM

(71) Applicant: SONES GMBH, Erfurt (DE)

(72) Inventors: Daniel KIRSTENPFAD, Erfurt (DE); Achim FRIEDLAND, Erfurt (DE)

(73) Assignee: Sones GmbH, Erfurt (DE)

(21) Appl. No.: 13/875,059

(22) Filed: May 1, 2013

Related U.S. Application Data
(63) Continuation of application No. 13/382,681, now abandoned.
Application No. 13/382,681 is a continuation of application No. 12/557,301, filed on Sep. 10, 2009, now abandoned.

(30) Foreign Application Priority Data
Jul. 7, 2009 (DE) DE102009031923.9

(51) Int. Cl. G06F 12/02

(52) U.S. Cl. CPC G06F 12/02
USPC 711/162; 711/170

(57) ABSTRACT

A method for the writing and reading of semi-structured data objects into a memory system is disclosed. The writing method comprises transforming the semi-structured data object into a first data stream, allocating a first storage area for the semi-structured data object in the memory system, writing the first data stream to the allocated first storage area, and creating at least one data object locator indicative of the commencement of the allocated first storage area; and updating the inode to reflect the new storage area of the updated object locator.

This non-provisional application is a continuation of application Ser. No. 13/382,681, filed on Jan. 5, 2012, which claims priority to international patent application No. PCT/EP2010/0059750 filed on Jul. 7, 2010, which is a continuation-in-part of U.S. patent application Ser. No. 12/557,301 filed on 10 Sep. 2009, and claims priority under 35 U.S.C. § 119(a) to German Patent Application No. 10 2009 031 923.9, which was filed in Germany on Jul. 7, 2009, all of which are incorporated herein by reference.

### FIELD OF THE INVENTION

The invention relates to a method and system for writing and reading of data objects on storage media.

### DESCRIPTION OF THE BACKGROUND ART

One goal of data management is safe storage of and, rapid, access to data objects on storage media. The data objects can be, but are not limited to, documents, audio files, video files, data records in a database, and more generally semi-structured data. Previous technical solutions for safe, high-performance storage and versioning of data objects divided the problem into multiple component problems, each of the multiple component problems were treated independently from one another.

It is known, in a conventional system, to associate a file system FS with at least one storage medium M (as seen in FIG. 1). In the case illustrated in FIG. 1, the file system FS is a format and a management information for storage of data objects on a single storage medium M. If multiple ones of the storage media M are present in a computing unit, then each of the storage media has an individual instance of the file system FS.

It is also known in the art that the storage medium M may be divided into partitions P. Each of the partitions P is assigned its own file system FS. The type of partitioning of the storage medium M is stored in a partition table PT on the storage medium M.

To increase access speed and protection of data (redundancy) from technical failures such as the failure of a storage medium M, it is possible to set up so-called RAID systems (Redundant Array of Inexpensive Disks), as illustrated in FIG. 2. In these RAID systems, multiple storage media M1, M2, etc. are combined into a single virtual storage medium VM1. In more modern variants of this RAID system (as shown in FIG. 3), the individual ones of the multiple storage media M1, M2 are combined into storage pools SP, from which virtual RAID systems with different configurations can be derived. In these prior art systems, there is a strict separation between the storage and management of data records in data objects and directories and a block-based management of RAID systems.

It is known that a block is the smallest unit in which the data objects are organized on the storage medium M1, M2. A block can e.g. consist of 512 or 4096 bytes. The storage space a file requires on the storage medium M does not exactly match the quantity of data in the file. Let us take an example. A file has for example bytes of data. The storage space required corresponds to at least the next larger multiple of the block size (20 blocks×512 bytes=10240 bytes.

Another issue in the prior art systems for the management of the reading and writing of the data objects is versioning or version control. The aim of version control is to record changes to the data objects so that it is always possible to trace what part of the data object was changed at what time by which one of users of the data object. Similarly, older versions of the data objects must be archived and reconstructed as needed. Such version control is frequently accomplished by means of so-called “snapshots” in the prior art. In the snapshot process, a consistent state of the storage medium M at the time of creation of the snapshot is saved in order to enable protection against both technical and human failures leading to possible corruption of the data object. The goal is for subsequent write operations to write only the data blocks of the data objects that have been changed since the time point of the preceding snapshot. The changed data blocks are not overwritten, however, but instead the changed data blocks are moved to a new position on the storage medium M, so that all versions of the data object are available with the smallest possible memory requirement. This means that the version control takes place purely at the level of the data block.

It is known that protection from disasters, for example the failure of storage media, can be achieved through the use of external backup software that implements complete replication of the data objects of the storage media M as a backup-based storage solution. In this case, the user can neither control the backup nor access the backed-up data objects without the help of an administrator aware of the issue.

The management and maintenance of the RAID systems and the backup-based storage solutions require a considerable amount of technical and staff resources on account of the complex architecture of these RAID systems and backup based storage solution. Nevertheless, at run time neither the users nor the administrators of such backup-based storage solutions can directly influence operation of the external backup software and thus the measures for the stored data objects. Thus, for example, as a general rule neither the level of redundancy (the RAID level) of the overall storage solution nor the level of redundancy of the individual data objects or older versions of these data objects can be changed without reinitializing the overall storage system or the file system and restoring the backup.

Similarly, enlarging or reducing capacity of the overall storage system is only possible in isolated cases and in very special circumstances. FIG. 4 shows an example of the enlargement of the overall system. FIG. 4 illustrates the RAID system with four storage media M1 to M4, each of which has a size of 1 Tbyte. On account of the redundancy of the data objects, a total of 3 Tbytes of this storage media M1 to M4 is available for the storage of the data objects. If one of the storage media M1 to M4 is replaced by a larger sized one of the storage medium M1 to M4, e.g. a larger storage medium with twice the size, 2 Tbyte, then it is necessary to implement a time-consuming resynchronization procedure in order to reestablish the redundancy of the data objects before the RAID system can be operated in the usual manner. The total storage space available for data objects remains unchanged until all four of the storage media M1 to M4 have been replaced one by one by larger storage media. Only then is 6 Tbytes of storage space out of the new total of 8 Tbytes of storage space available for the storage of the data objects. The resynchronization is necessary after each replacement of one of the storage media M1 to M4.

The restrictions in the prior art solution result from the fact that the granularity of the data (the fineness of distinction) of these backup measures can only be tied to the physical or logical storage media or file systems. The architecture of these prior art storage systems means that a finer distinction among the requirements of the individual data objects or revisions of the data objects is impossible. In some prior art cases the finer distinction is simulated by a large number of subsidiary virtual storage or file systems.

It is also known that prior art storage systems are based on a layered model in the architecture of the storage medium in order to be able to distinguish between different operating states in different layers in a defined manner, as will be explained below. The lowest layer of the layered model is a storage medium M, for example.

This storage medium M has the following features and functions: Media type (tape drive, hard disk, flash memory, etc.; Access method (parallel or sequential); Status and information of self-diagnostics; Management of faulty blocks.

Located as the next layer above this lowest layer is, for example, the RAID layer, which may be implemented as a RAID software or as a RAID controller.

The following features and functions are allocated to this RAID layer: Partitioning of storage media; Allocation of storage media to RAID groups (active, failed, reserved); Access rights (read only/read and write).

Located above the RAID layer is, for example, a file system layer (FS) with the following features and functions: Allocation of data objects to blocks; Management of rights and metadata; Each of the layers of the layer model communicates only with the adjacent layers located immediately above and below the communicating layer. This layer model has the result that the individual ones of the layers do not have the same information about the storage of the data objects on the storage media. This architecture is intended in the prior art for the purposes of reducing the complexity of the individual systems as well as to enable standardization and increasing the compatibility of components from different manufacturers.

It is known that each one of the layers depends on the layer below. Accordingly, in the event of a failure of one of the storage media M1 to M4, the file system FS does not know which one of the storage medium M1 to M4 of the RAID group has just failed and cannot inform the user of the potential absence of redundancy of the data objects. On the other hand, after the failed one of the storage medium M1 to M4 has been replaced with a functioning one of the storage media, the RAID system must undertake a complete resynchronization of the RAID system, despite the fact that only a few percent of the data objects in the RAID system are affected in most cases, and this information is present in the file system FS.

It is also known that modern ones of the storage systems attempt to ensure a consistent state of the data structures of the storage system with the aid of so-called journals. All changes to the management data for a file are stored in a reserved storage area, called the journal, prior to the actual writing of all of the changes. It is known that the actual user data are not captured, or are only inadequately captured, by this journal, so that data loss can nonetheless occur.

In the article “Exploiting the performance gains of modern disk drives by enhancing data locality” (Information Science 179 (2009) 2494-2511) the author Yaqui Deng describes how the disk access performance of disk drives can be improved by enhancing data locality. This publication describes the distribution of data blocks on a modern hard disk drive. Based on the characteristics and the observation that data access on disk drives is highly skewed, the frequently accessed data blocks and the correlated data blocks are clustered into objects and moved to the outer zones of the disk drive.

### SUMMARY OF THE INVENTION

The description discloses a method for the reading and writing of semi-structured data objects into a memory system, a data storage and retrieval device for the memory system, and a computer program product having control logic stored therein for causing a processor to execute a method for the reading and the writing of the semi-structured data objects into the memory system.

In one aspect of the method and memory system a storage control module is allocated to each ones of the storage media. A file system communicates with each of the storage control modules—The storage control module obtains information about the storage medium, The information includes, at a minimum, a latency, a bandwidth, details on a number of concurrent read/write threads and information on occupied and free available storage blocks on the storage medium. All information about the allocated storage medium is forwarded to the file system by the storage control module. This means that, unlike in a layer model, the information is not limited to communication between adjacent layers, but instead is also available to the file system and, if applicable, to layers above it. Because of this simplified layer model, at least the file system has all information about the entire storage system, all storage media, and all stored data objects at all times. As a result, it is possible to carry out optimization and react to error conditions in an especially advantageous manner. Management of the storage system is simplified for the user. For example, during replacement of a storage medium that forms a redundant system (such as a RAID-like redundancy system) together with multiple other storage media, significantly faster resynchronization can take pace, since the file system has the information about occupied and free blocks, and hence only the occupied and affected blocks need be synchronized. The RAID-like system is operational again potentially within seconds, in contrast to conventional systems, for which a resynchronization may take several hours. In addition, when a storage medium is replaced by a replacement storage medium with larger capacity, the larger capacity is made available in a simpler manner and at an earlier time than in the prior art.

Information about each of the data objects can be maintained in the file system, including at least its identifier, its position in a directory tree, and metadata containing at least an allocation of the data object. The allocation of the data object indicates its storage location on at least one of the storage media.

In an aspect of the method, the allocation of each of the data objects can be selected by the file system based on the information about the storage medium and based on predefined requirements for latency, bandwidth and frequency of access required for this data object. This means, for example, that a data object that is needed very rarely or with low priority can be stored on a tape drive (one example of the storage medium), while a data object that is needed more frequently is stored on a hard disk, and a data object that is needed very frequently may be stored on a SSD or RAM disk. The RAM disk is a part of working memory that is generally volatile but in exchange is especially fast.

A level of redundancy of each of the data objects can be selected by the file system on the basis of a predefined minimum requirement for the redundancy of the data object. This means that the entire storage system need not be organized as a RAID system with a single RAID level (redundancy level). Instead, each data object can be stored with an individual value for the level of redundancy. The metadata concerning the redundancy level selected for a particular one of the data objects is stored directly as an attribute with the data object as part of the management data. It is also possible that the data objects inherit some or more of their attributes in their metadata from higher level objects (such as, but not limited to, from the directory, path or parent directory level

As additional information about the storage medium, measures of speed of read access from and write access to the storage medium can be determined. The measures of speed reflects how rapidly previous accesses have taken place and the degree to which different storage media can be used simultaneously and independently of one another. In addition, the number of parallel accesses that can be used with a particular one of the storage media can be determined. Taking this information into account in the allocation of the data object to the storage media reflects reality even better than merely using the values for the latency and bandwidth determined by the storage control module. For example, the storage control module can access a remote storage medium over a network. In this context, the availability of the storage medium is also a function of the utilization of capacity and topology of the networks, which are thus taken into account.

The allocation of the data objects can be extent-based. An extent is a contiguous storage area encompassing several blocks of data. When the data object is written, at least one such extent is allocated to the data object. In contrast to block-based allocation, large ones of the data objects can be stored more efficiently using the extent-based allocation, since in the ideal case one the extent fully reflects the required storage area of a data object, and it is thus possible to save on management information.

In one aspect of the invention, the copy-on-write semantic is used. This means that write operations always take place only on copies of the actual data object to be amended (also termed updated). Thus a copy of the existing data object is made before the existing data object is updated. This copy-on-write semantic ensures that at least one consistent copy of the object is present even in the case of a disaster. The copy-on-write semantic protects the management data structure of the overall storage system in addition to the data objects. Another possible use of the copy-on-write semantic is for creating snapshots for versioning of the overall storage system.

As already described, it is possible to use as a storage medium a hard disk, a portion of a working memory, a tape drive, a remote storage medium on a network, or any other storage medium (but this list is not-limiting of the invention). In this regard, the information about the storage medium that is passed on is, at minimum, whether the storage medium is volatile or nonvolatile. It is known that a working memory is suitable for storage of frequently used data objects on account of the short access times and high bandwidth of the working memory. The volatility of the working memory means, however, that the working memory provides no data protection in a power outage. The information about the type of the storage medium also enables a decision to be made about whether to cache the data or not. Data that is stored in the working memory does not need to be cached, as the data is easily and quickly available. There is no advantage of storing this data in the cache.

During a read operation on the storage medium, an amount of data larger than that requested can be sequentially read in and buffered in a volatile memory (generally termed a cache). This method is called read-ahead caching.

Similarly, during intended write operations on the storage medium, the data objects from multiple ones of the write operations can be initially buffered in a volatile memory and can then be sequentially written to the storage medium. This method is called write-back caching.

The read-ahead caching and write-back caching are caching methods that have the goal of increasing read and write performance to the storage medium. The read-ahead method exploits the property—primarily of hard disks—that sequential read accesses to similar physical locations on the hard disks can be completed significantly faster than random read accesses over the entire area of the hard disk. For random read operations, the read-ahead cache mechanism strives to keep the number of such random read accesses as small as possible. It is known that under some circumstances, somewhat more data objects than the single random read operation would require in and of itself are read from the hard disk—but are read sequentially, and thus faster.

A hard disk is organized such that, as a result of its design, only complete internal disk blocks (which are different from the blocks of the storage system) are read. In other words, even if only 10 bytes are to be read from a hard disk, a complete internal disk block with a significantly larger amount of data (e.g., 512 bytes) is read from the hard disk. In this process, the read-ahead cache can store up to 512 bytes in the cache without any additional mechanical or computing effort.

The write-back caching takes a similar approach with regard to reducing mechanical operations. It is most practical to write data objects sequentially. The write-back cache makes it possible, for a certain period of time, to collect the data objects for writing and potentially combine the data objects for writing into larger sequential write operations. This makes possible a small number of sequential write operations instead of many individual random write operations.

The method and system of this disclosure enable a strategy for the read or write operation, in particular the aforementioned read-ahead and write-back caching strategy, which can be selected on the basis of the information about the storage medium. This is referred to as adaptive read-ahead and write-back caching. The method is adaptive because the storage system strives to deal with the specific physical characteristics of the storage media. It will be appreciated that non-mechanical flash memory requires a different read/write caching strategy than mechanical hard disk storage.

In one aspect of the invention the data object can be protected by a checksum in order to ensure the integrity of the data object. A data stream which contains the data object can be protected by the checksum. A data stream can comprise one or more extents. Each of the extents can in turn comprise one or more contiguous blocks on the storage medium.

It will be appreciated that, in addition, the data stream can be subdivided into checksum blocks. Each of the checksum blocks of the data stream can be protected by an additional checksum. The checksum blocks are blocks of predetermined maximum size for the purpose of generating checksums over “sub-regions” of the data stream.

It will also be appreciated that provision can be made to compress the data objects for writing the data objects onto the storage medium. The data objects are subsequently decompressed after reading. This compression and decompression of the data objects is carried out in order to save storage space on the storage medium. The compression and decompression can take place transparently. This means that it makes no difference to a user application whether the data objects that are read were stored on the storage medium compressed or uncompressed. The compression and management work is handled entirely by the storage system.

In an aspect of the invention, multiple ones of the data objects can be organized and placed in relation to one another (linked by edges), as is known in the manner of a graph. Such a graph-like linking is implemented by the means that an object location, which is to say a position of a data object in a path, has allocated to an attribute which links to the location of another data object. Such linkages can be created and managed in a database placed upon the file system as an application.

An interface can be provided for user applications, by means of which functionalities related to the data object can be extended. This is referred to as extendible object data types. For example, a functionality can be provided in the form of a plug-in that makes available full-text search on the basis of a stored object. Such a plug-in could extract a full text, process the full text, and make it available for searching by means of a search index.

The metadata relating to the data object can be made available at the interface by the user application. A plug-in-based access to object metadata achieves the result that the plug-ins can also access the management metadata, or management data structure, of the storage system in order to facilitate expanded analyses of the data objects in the storage system.

One possible scenario is an information lifecycle management plug-in that can decide, based on the access patterns of individual ones of the data objects, on which one and which type of the storage medium and in what manner an object is stored. For example, in this context the plug-in should be able to influence attributes such as compression, redundancy, storage location, RAID level, etc.

The user interface can be provided for a compression and/or encryption application selected and/or implemented by the user (and as briefly described above). This ensures a trust relationship on the part of the user with regard to the encryption. This complete algorithmic openness permits gapless verifiability of encryption and offers additional data protection.

In another aspect of the disclosure, a virtual or recursive file system can be provided, in which multiple file systems are incorporated. The task of the virtual file system is to combine the multiple file systems into an overall file system and to achieve an appropriate mapping of the multiple file systems to the overall file system. For example, when a file system has been incorporated into the storage system under the alias “/FS2,” the task of the virtual file system is to correctly resolve this alias during use and to direct an operation on “/FS”/directory/data object” to the subpath ‘/directory/data object’ on the file system under “/FS2.” In order to simplify the management of the virtual file system, there is the option of recursively incorporating file systems into other virtual file systems.

Information such as the system metadata creation time, last access time, modification time, deletion time, object type, version, revision, copy, access rights, encryption information, and membership in object data streams can be associated as attributes with the data object.

At least one of the attributes of integrity, encryption, and allocated extents can be associated with the object data stream.

During replacement of one of the storage media, a resynchronization is performed in which the storage location and the redundancy for each data object can be determined anew on the basis of the minimum requirements predefined for the data object.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein and the accompanying drawings which are given by way of illustration only, and thus, are not limiting of the present invention, and wherein:

FIG. 1 shows a layer model of a simple storage system according to the conventional art.

2 shows a layer model of a RAID storage system according to the conventional art.

FIG. 3 shows a layer model of a RAID storage system with a storage pool according to the conventional art.

FIG. 4 shows a schematic representation of a resynchronization process on a RAID storage system according to the conventional art.

FIG. 5A shows a schematic representation of a file system with a plurality of storage media M1 to M3.

FIG. 5B shows a schematic representation of the storage media.

FIG. 6 shows a schematic representation of the use of checksums on data streams and extents.

FIG. 7 shows a schematic representation of an object data stream and the use of checksums.

FIG. 8 shows a flow diagram of a read access in the storage system.

FIG. 9 shows a representation of a write access in the storage system.

FIG. 10 shows a schematic representation of a resynchronization process on the

FIG. 11 shows the data structure associated with an inode and an object locator.

FIG. 12 shows an example of a use application using the memory storage system.

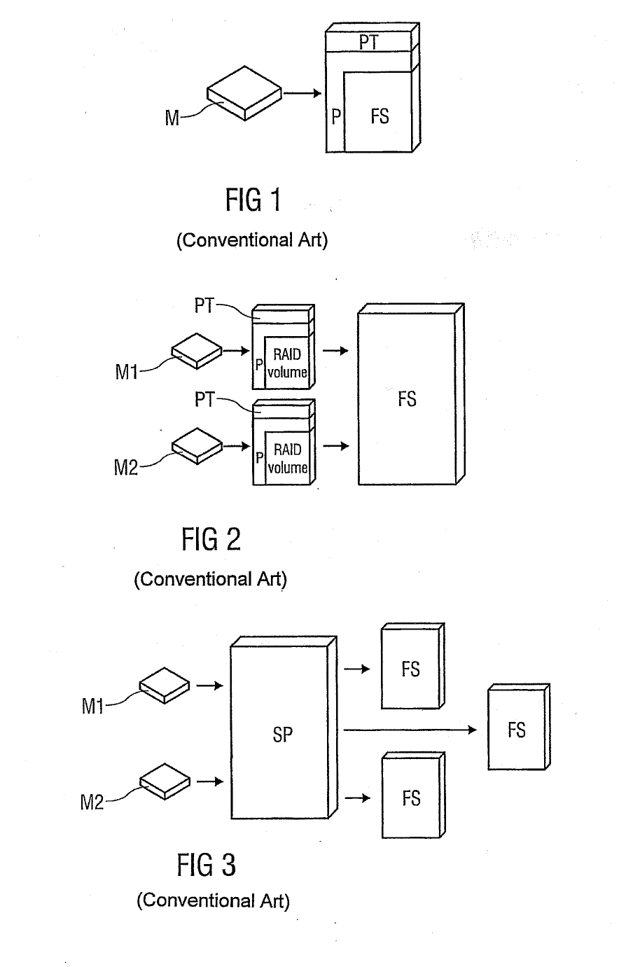

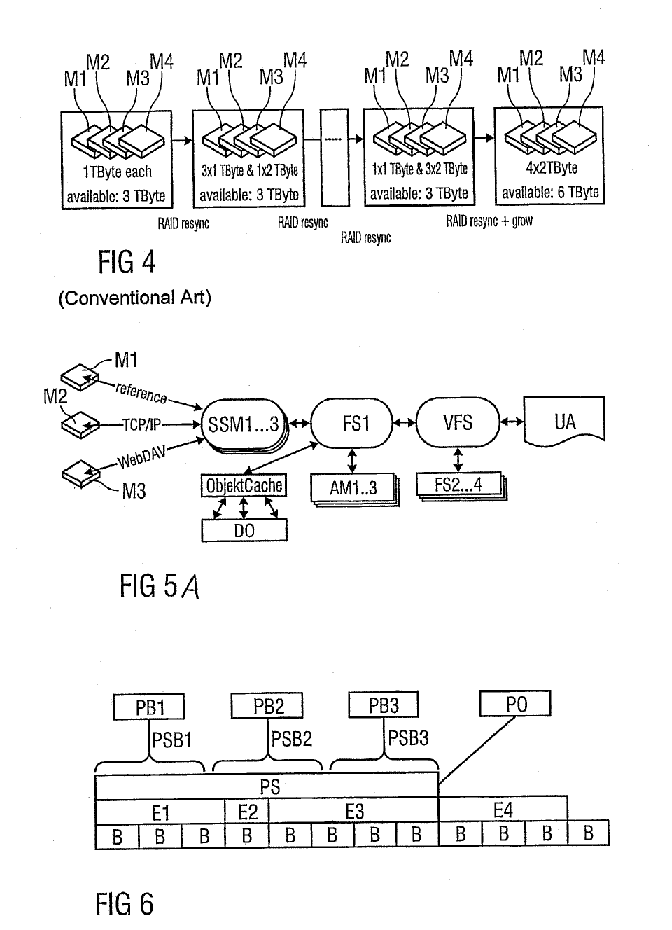

### DETAILED DESCRIPTION

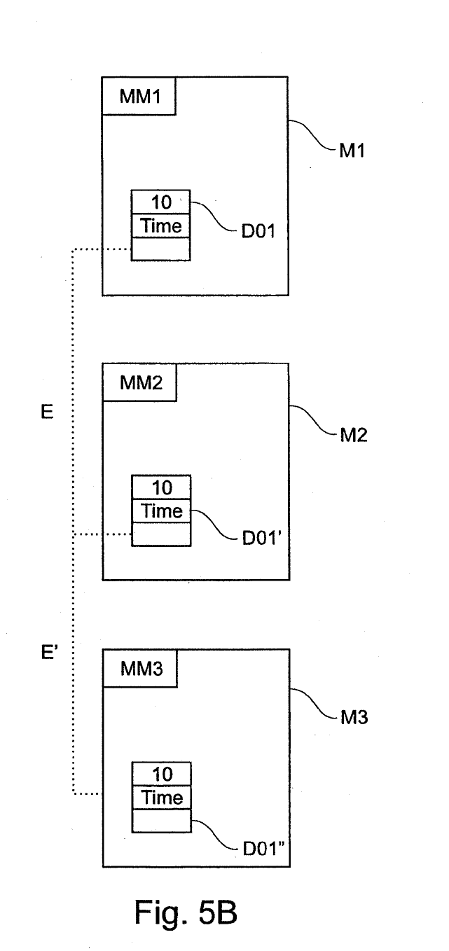

FIG. 5A shows a schematic representation of a file system with a plurality of storage media M1 to M3. A storage control module SSM1 to SSM3 is allocated to each one of the storage media M1 to M3. The storage control modules SSM1 to SSM3 are also referred to as storage engines and may be implemented either in the form of a hardware component or as a software module. A file system FS1 communicates with each one of the connected storage control modules SSM1 to SSM3. The storage control module SSM1 to SSM3 obtains information about the particular storage medium M1 to M3. This information includes information about whether the storage medium M1 to M3 is volatile or non-volatile, a latency, a bandwidth, and information on occupied and free storage blocks on the storage medium M1 to M3. All the information about the allocated storage medium M1 to M3 is forwarded to the file system FS1 by the storage control module SSM1 to SSM3.

The storage system has a so-called object cache, in which desearalised ones of the data objects DO are buffered. Provided in the file system FS1 for each of the storage media M1 to M3 is an allocation card (allocation map) AM1 to AM3, wherein is recorded which blocks of the storage medium M1 to M3 are allocated for each one of the data object stored on at least one of the storage media M1 to M3. Provided above the file system FS1 is a virtual file system VFS, which manages multiple file systems FS1 to FS4, maps multiple file systems FS1 to FS4 into a common storage system, and permits access to the multiple file systems FS1 to FS4 by a plurality of user applications UA through an user interface.

Communication with the user or the user application UA takes place through the user interface in the virtual file system VFS. By this means, in addition to the basic functionality of the storage system, additional functionality such as metadata access, access control, or storage media management are made available to the user or the user application. In addition to this interface, the primary task of the virtual file system VFS is the combination and management of different file systems FS1 to FS4 into an overall storage system.

The actual logic means of the storage system is hidden in the file system FS1 to FS4. This is where the communication with, and management of, the storage control modules SSM1 to SSM3 takes place The file system FS1 to FS4 manages the object cache, takes care of allocating storage regions on the individual ones of the storage media M1 to M3, and takes care of the consistency and security requirements of the data objects

The storage control modules SSM1 to SSM3 encapsulate the direct communication with the actual storage medium M1 to M3 through different interfaces or network protocols. The primary task in this regard is ensuring communication with the file system FS1 to FS4.

It will be appreciated that a number of file systems FS1 to FSn, and a number of storage media M1 to Mn, can be provided and that the number differ from the numbers shown in FIG. 5A.

In one aspect of the description, the storage system can have the following characteristics: Internal limits (for 64 bit address space by way of example): 64 bits per file system FS1 to FSn which means that at least (2⁶⁴ bytes are addressable); 2⁶⁴ file systems FS1 to FSn possible at a time (which are integrated into the virtual file system VFS); Maximum of 2⁶⁴ bytes per file; Maximum of 2⁶⁴ files per directory,

Maximum of 2⁶⁴ bytes per (optional) metadata item; Maximum of 2³¹ bytes per object-/file-/ directory name; Unlimited path depth

It will be appreciated that corresponding different limits can apply for a different address spaces (for example, an address space of 32 bits).

FIG. 5B shows a schematic representation of the plurality of storage media M1 to Mn (in this case three, i.e. M1 to M3). Each one of the plurality of the storage media has a memory management module MM1 to MM3. The function of the memory management modules MM1 to MMn is to manage the storage media in general. This management of the storage media involves the following features: An extent-based allocation strategy within an allocation map in the memory management module MM1 to MM3; Different allocation strategies (e.g. delayed allocation) for different requirements on different ones of the plurality of storage media M1 to Mn; Copy-on write semantic, automatic versioning; Read-ahead and write-back caching; Temporary object management for data objects DO that are only kept in volatile working memory;

FIG. 5B shows three data objects DO1, DO1′ and DO1″ on different ones of the plurality of storage media M1 to Mn. It will be appreciated that this example is only exemplary. It is possible, for example, that there are a number of data objects on each one of the storage media M1 to Mn. It will be assumed for the sake of example that data object DO1 is the first version of a data object. The data object DO1 as shown in FIG. 5B, has a number of attributes associated with the data object DO1. In the FIG. 5B only attributes are shown an object ID and a time stamp. The object ID is a unique object ID that indentifies this data object DO1 stored on the storage media M1. The time stamp shows the time that the data object DO1 was stored on the memory media M1

Similarly data object DO1′ also contains two data objects attributes, an object ID which is the object ID of the data object DO1 and the time stamp which shows the time at which the data object DO1 was stored on the storage media M2. In addition the data object DOV has an attribute which points to the data object DO1 and is indicated on the FIG. 5 by a dotted line or edge labeled E. This edge indicates that the data object DO1′ is an updated version of the data object DO1 stored on the storage media M1.

Similarly a further, updated data object DO1″ is stored on the storage media M3. The further updated data object DO1″ also has the object ID and a time stamp indicating the time at which the further updated data object DO1″ was stored on the storage memory medium M3. Similarly the further updated data object DO1″ has an attribute which points to the previous version of the further updated data object DO1″, i. e. the updated data object DO1 stored on storage media M2. This attribute is indicated as a dotted line labeled E′ on FIG. 5B.

The storage system of this disclosure can store multiple copies of the data object as the data objects are updated. There will be, however, a physical limit to the amount of the storage media available and therefore there is a default setting within the storage system which insures only a maximum number of copies are stored on the storage media on one or more of the storage media M1 to Mn.

It will be appreciated that the use of the time stamp attribute associated with each one of the data objects allows the reconstruction of the data objects in the event that some of the data is corrupted. Similarly the linking of the data objects along the edges through attributes allows a path between multiple versions of the data objects to be created. So, for example, if one of the data objects is corrupted, it should be possible to recreate a previous version of the data object by examining the time stamp attribute and the link attributes associated with each one of the data objects.

It will be appreciated that the storage system of this disclosure can be enlarged and reduced as desired (so-called grow and shrink functionality), The storage system also enables Integrated support of multiple storage media M1 to Mn per host and clustering for local multicast or peer-to-peer based networks.

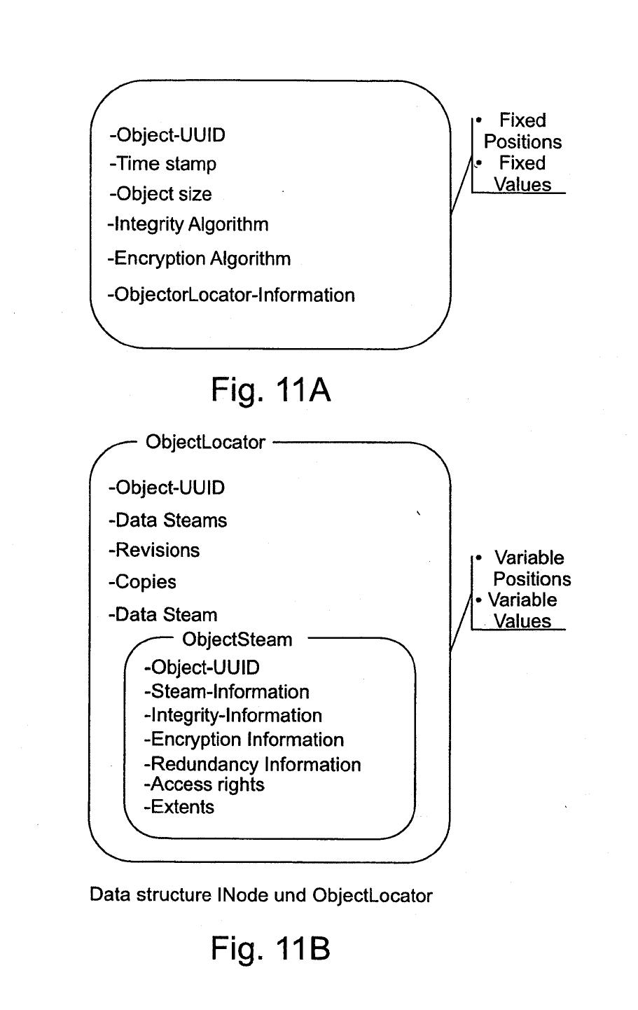

The file system includes an inode IN. The inode IN is an entry in a file system that contains metadata of the data object. An exemplary data structure of the inode is shown in FIG. 11 A. It will be seen that the inode has a attribute object ID, time stamp, object size, integrity algorithm, an encryption algorithm and object locator information. The object ID is the unique object identification number associated with the data object as discussed previously. The time stamp is the date and time at which this version of the data object was created. The object size indicates the total memory size required in the memory for the object. The integrity algorithm indicates which integrity algorithm has been used in order to store the data object on the storage media M1 to Mn. The encryption algorithm indicates which one of the plurality of encryption algorithms is used to encrypt the information contained in the data object and the object locator information indicates the location of the object locator, as will be explained later. It will appreciated by those skilled in the art, that the inode may contain further attributes without being limiting of this invention.

The inode is present in at least one original and one copy (and often several copies) on one or, preferably, more of the storage media M1 to Mn at a fixed location. This means that on start up of the memory storage device the inode can be identified. The modes have a fixed size.

The object locator indicates where the data object is stored on the storage media M1 to Mn and manages the data streams associated with the data object. FIG. 11 B shows the data structure of the object locator. The object locator has the following attributes: object-ID, data streams, revisions, copies and per each one of the data streams. For each one of the data streams the following attributes are present: Object-ID, stream-information, integrity-information, encryption-information, redundancy-information, access rights and extends.

The object-ID gives the identification number of the data object to which this object locator refers. The data streams attribute gives an indication of the number of data streams and their position on the storage media M1 to Mn. The attribute revisions refers to the number of revisions or updated copies of the data objects whereas the attribute copies refers to the number of identical copies on one or more of the different ones of the storage media M1 to Mn. The stream-information attribute gives general details of the type of stream and verities stored, whereas the integrity-information and the encryption-information provide integrity data and encryption data which is used in the integrity algorithms and the encryption algorithms, as indicated in the inode (see FIG. 11A). Each one of the object streams may have different access rights which are indicated in the attribute “access rights” and the extents are also indicated in an attribute.

A further attribute, an edition attribute, may also be associated with the different object streams. The edition attribute is used to indicate parallel ones of the object streams which contain identical data. For example, a data object for a photograph may be stored in one object stream in RAW format, in another data stream as high resolution JPEG format and in yet another data stream as a low resolution JPEG format. The edition attribute can also be used to indicate a “public” profile within a social network application, i.e. the data is accessible by all, and a “private” profile in which the data is only accessible to a limited number of selected users.

It will be appreciated that more than one object locator may be associated with each one of the data objects. This redundancy enables means that in the event of corruption of one of the object locators, the data object may still be accessed by a further object locator. It will be appreciated that on start-up of the storage system a bootstrap block is accessed in which a first object locator is stored (the root directory). The root directory will then contain links to all of the other object locators either directly or indirectly.

The data structure shown in FIG. 11A and FIG. 11b enables management processes for: Online storage system checking; Data structure optimization and defragmenting; Dynamic relocation of data objects; Performance monitoring of storage media (changing the write and read speed); Delete excess versions and copies when space is needed; Block-based integrity checking; Forward error-correction codes (i.e. convolution, Reed-Solomon); Ensuring of consistency by means including keeping multiple copies of important management data structures Access protection through user allocations: Expandable using access control lists; Encryption of all structures and data objects: Algorithm selectable per data object; AES or self-implemented algorithm via plug-in interface; “Secret sharing” and “secret splicing” mode for individual data objects (splitting of information where the individual parts do not permit any inferences to be made concerning the original data objects.)

In addition, the following options can be provided:

Associative storage system: Here, the item of interest is not primarily the names of the individual objects, but instead the metadata associated with the objects. In such storage systems, the user can be provided with a metadata-based view of the data objects in order to simplify finding or categorizing data objects.

Direct storage of graph-based data objects: The data objects can be stored directly, securely and in a versioned manner in the form of graphs (strongly interconnected data, as discussed in connection with FIG. 5A).

Offline backup: Revisions of objects in the storage system can be exported to an external storage medium separately from the original object. This offline backup is comparable to known backup strategies, where in contrast to the prior art the method and device of the disclosure manages the information about the availability and the existence of such backup sets. For example, when an archived data object on a streaming tape is being accessed, the entire associated graph (linked data objects) can be read in as a precaution in order to avoid additional time-consuming access to the streaming tape.

Hybrid storage system: Hybrid storage systems carry out a logical and physical separation of storage system management data structures and user data. In this regard, the management data structures can be assigned to very powerful storage media in an optimized manner. In parallel therewith, the user data can be placed on less powerful and progressively less expensive storage media.

The reliability of the data objects can be used by using checksums, as discussed above. FIG. 6 shows a schematic representation of the use of checksums on one of the data streams DS and extending over the extents E1 to E3. The integrity of data objects DO is ensured by a two-step process. In the first step we use the checksum PO of the entire data object DO. In this process, a checksum PO for the entire object stream DS—serialized as a byte data stream—is calculated and stored. In the second step the object stream DS itself is divided into checksum blocks PSB1 to PSB3. Each one of these checksum blocks PSB1 to PSB3 is provided with a checksum PB1 to PB3.

For the sake of clarity it will be noted that the checksum blocks are different from the blocks B of the storage medium. Blocks B of the storage medium M1 to Mn (for example implemented as a hard disk) are internally used by the storage medium M1 to Mn as units of organization. Several of the blocks B form a sector. A size of the sector generally cannot be influenced from outside, and results from the physical characteristics of the storage medium M1 to Mn, of the read/write mechanics and electronics, and the internal organization of the storage medium M1 to Mn. Typically, these blocks B are numbered 0 to n, where n corresponds to the number of blocks B. The extents E1 to En combine a block B or multiple blocks B of the storage medium into storage areas. They are not normally protected by an external checksum.

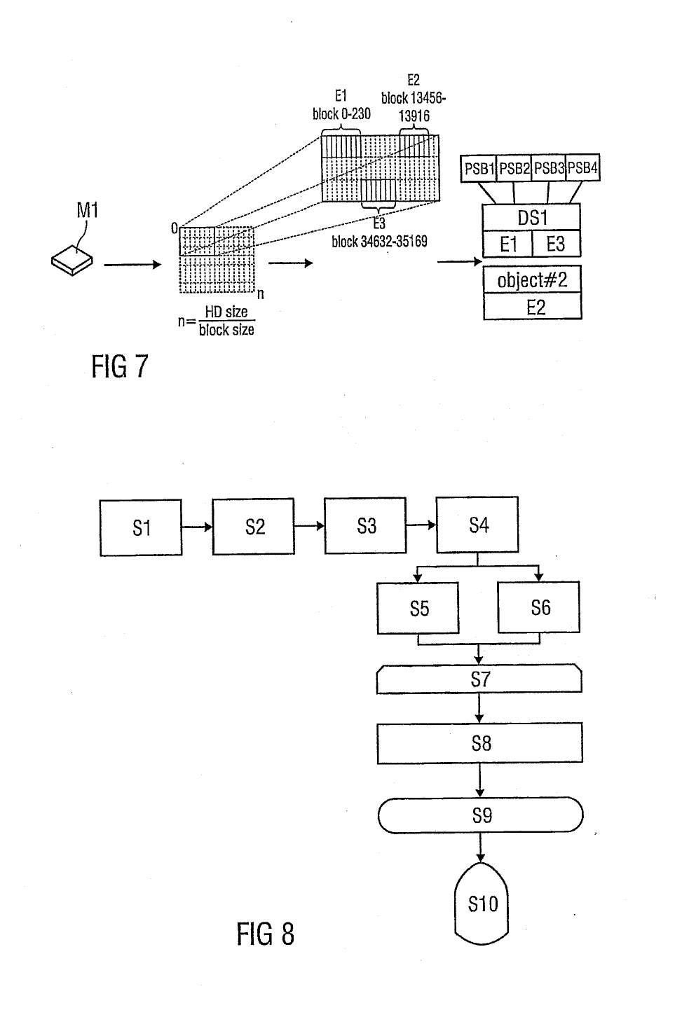

The object streams DS are byte data streams that can include one extent E1 to En or multiple extents E1 to En. Each one of the object streams DS is protected by a checksum PO. Each object stream DS is divided into checksum blocks PSB1 to PSBn. Object streams, directory data streams, file data streams, metadata streams, etc, are special cases of a generic data stream DS and are derived therefrom. The checksum blocks PSB1 to PSBn are blocks of previously defined maximum size for the purpose of producing the checksums PB1 to PBn over subregions of one of the data streams DS. In FIG. 7, the data stream DS1 is secured by four checksum blocks PSB1 to PSB4. Thus four checksums PB1 to PB4 are calculated. In addition thereto, the data stream DS1 also has its own checksum PO over the entire data stream DS1.

FIG. 8 shows a flow diagram of a read access in the storage system of the disclosure, for reading a data object DO is read. First, the reading of the data objects DO is requested through the virtual file system VFS, by specifying a path to the data object DO on the storage system (Step S1). The file system FS1 examines the directory and supplies the address of the inode for the data object with the aid of the directory in Step S2. In a step S3, the Inode belonging to the data object DO is read via the file system FS1, and in a Step S4 the object locator relating to the data object is identified from the attribute “ObjectLocator-Information”, as shown in FIG. 11A.

The identification of a storage layout and the selection of storage IDs as well as the final position and length on the actual storage medium take place in further steps S5, S6, S7.

In step S5 the different types of memory layouts on which the object streams containing the data of the data object are stored are determined by examining the attributes in the data structure of the object locator. In step S6 the storage IDs for each one of the object streams are generated from the attributes in the object locator.

The storage ID designates a unique identification number of one of the storage medium. This storage ID is used exclusively for the selection and management of the storage media.

In step S7 the position of the data stream (or data streams) to be read, as well as the length of the data stream(s) is determined. The actual reading of the data streams for the data in the data object are then carried out by the storage control module SSM1 using the identified storage ID (Step S8). It will be appreciated that multiple ones of the data streams may be read at the same time. In a Step S9, the file system FS1 assembles the data streams into a data stream DS1, if necessary, and returns the data streams DS1 to the virtual file system VFS (Step S10). This is necessary, for example, when the data object DS1 is stored so as to be distributed across storage media M1 to Mn (as is known in the RAID system).

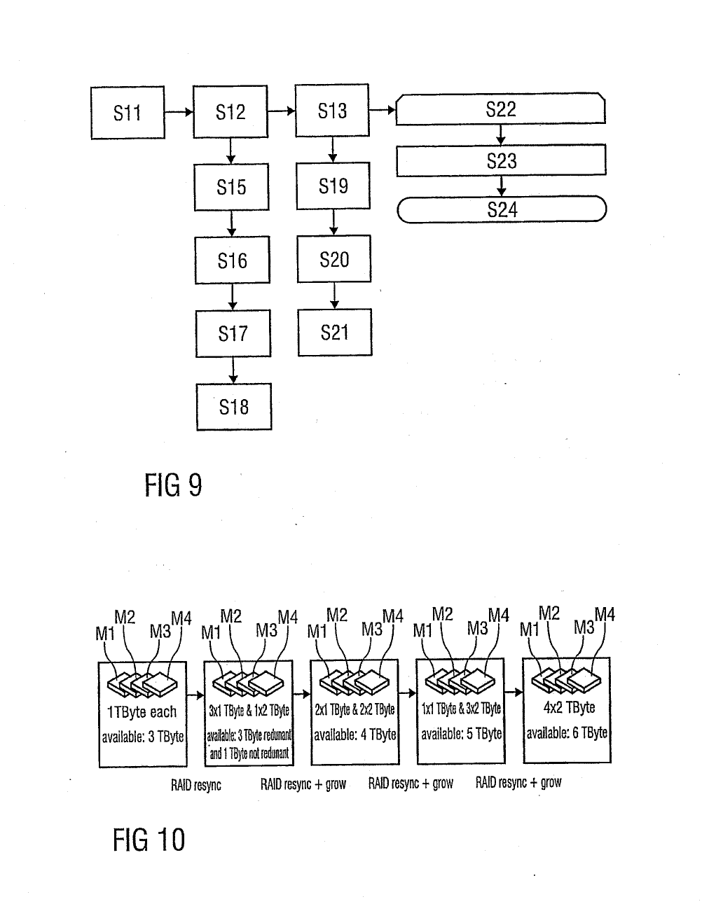

In an analogous manner, FIG. 9 shows a representation of writing the data object to the storage system. In step S11 the writing of the data object DO is requested through the virtual file system VFS and a path to the data object is specified. The file system FS1 creates and allocates an inode having the data structure shown in FIG. 11a in a step S12 and an object locator in a step S13.

During creation of the inode in the step S12, the directory object with the locations of the inodes IN is found and read by the virtual file system VFS in a step S15. In this directory, the location of the inode IN is entered under the name of the data object by the file system FS1 in a step S16.

During creation of the object locator in step S13, one or more storage IDs are set in a step S19 by the file system FS1. The object data streams DS1 are allocated in step S20 to the areas of the storage media identified by the one or more storage IDS. The object locator is written in step S21. It will be appreciated that for every one of the data stream DS1 to DSn to be written, the file system FS1 requests the writing of the different ones of the data streams DS1 in a step S22. This writing of the different ones of the data streams DS1 is then carried out by the storage control module SSM1 in a step S23.

After the data object DO has been written in step S23, the inode IN is written in a step S17 on the area of the storage media allocated to inodes IN. It will be recalled that at least two copies of the inode IN are written to different ones of the storage media. Finally the directory (directory object) is written in a step S18. The writing of the inode in the step S17 is only carried out after the data object DO has been completely written to the storage media. The reason for this is that should the storage media be corrupted during the writing of the data object DO, then the inode IN will not erroneously point to a corrupted data object DO. This is particularly important when updating the data in the data object. It will be recalled that the update of the data in the data object DO results in a completely new data object being created with a link (edge) to an older version of the data object. It is important that the inode IN is only written once it is clear that there is a good version of the data object.

In a step S24 the completion of the writing of the data object is communicated to the virtual file system VFS.

FIG. 10 shows a schematic representation of a resynchronization process on the storage system. In the example selected, the storage system includes four storage media M1 to M4, but this is not limiting of the invention. Each one of the four storage media M1 to M4 initially has a size of 1 Tbyte. Due to the redundancy in the RAID system, a total of 3 Tbytes of this storage space is available for the data objects DO. If one of the storage media M1 to M4 is now replaced by a larger storage medium M1 to M4 with twice the size, i.e. 2 Tbytes, the resynchronization process is necessary in order to reestablish the redundancy before the RAID system can be used in the customary manner again.

The storage space available for the data objects DO initially remains unchanged in this process for the same redundancy level. The additional terabyte of storage space on the replaced one of the storage medium M1 to M4 is only available without redundancy at first. As soon as another one of the storage media M1 to M4 is replaced by a large one with 2 Tbytes, 4 Tbytes are available for redundant storage after the resynchronization. It will be appreciated that the available space becomes 5 Tbytes when a third of the storage media M1 to M4 is replaced, and 6 Tbyte when the fourth of the storage media is replaced. T

The resynchronization is required after each replacement of one of the storage media M1 to M4. No unnecessary data objects need be moved or copied in this process, since the storage system of this disclosure has the information as to which ones of the data blocks are occupied with data objects and which ones of the data blocks are free. Thus, only the metadata needs to be synchronized. It is not necessary to resynchronize all allocated and unallocated blocks of the storage media M1 to M4. The resynchronization can be carried out more rapidly.

The redundancy levels (RAID levels) in the storage system are not rigidly fixed. Instead, it is only specified what redundancy levels must be maintained as a minimum. During resynchronization, it is possible to change the RAID levels and decide from data object to data object on which storage media M1 to M4 the data object will be stored and with what level of redundancy.

Information on each of the data objects DO can be maintained in the file system FS1 to FSn, including at least its identifier, its position in a directory tree, and the metadata containing at least an allocation of the data object DO, i.e, its storage location on at least one of the storage media M1 to Mn.

It will be appreciated that the allocation of each of the data objects DO can be chosen by the file system FS1 to FSn with the aid of information on the storage medium M1 to Mn and with the aid of predefined requirements for latency, bandwidth and frequency of access for this data object DO.

Similarly, it will be appreciated that a redundancy of each of the data objects DO can be chosen by the file system FS1 to FSn with the aid of a predefined minimum requirement with regard to redundancy.

It has been noted that the storage location of the data object DO can be distributed across at least two of the storage media M1 to Mn.

It has been noted that as additional information about the storage medium M1 to Mn, a measure of speed can be determined, which reflects how rapidly previous accesses have taken place.

In one aspect of the invention, the allocation of the data objects DO can be extent-based. Different data streams are written across more than one extent. Extents can, but do not generally have, a fixed length. The advantage in using extents is that they enable an accurate record of the allocation of space for the data objects on any one of the storage media M1 to Mn.

It has been noted that the storage method and system of the disclosure enable provision to be made to compress the data objects DO for writing and to decompress them after reading in order to save storage space. The compression/decompression can take place transparently.

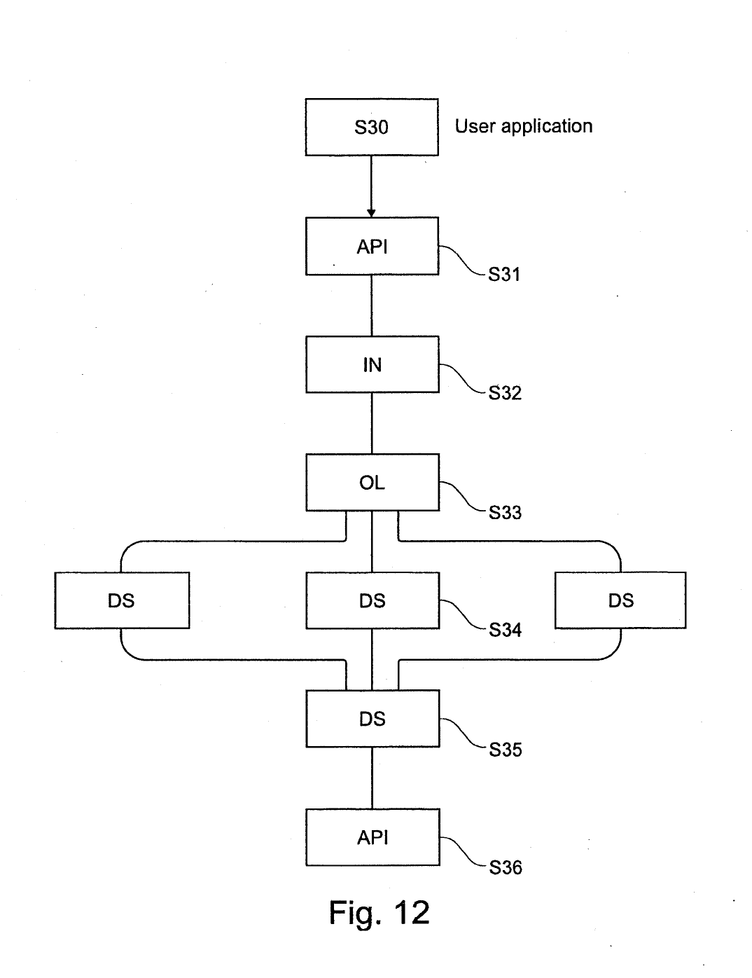

An example of a user application using the memory storage system and method of this disclosure is given in FIG. 12. In a step S30, the user application wishes to access a data object. The user application has the name of the data object and the path to the data object. The user application calls in step S31 the API of the memory storage system and method and the file system receives the name of the data object and the path to the date object. The file system is able to identify the location of the inodes IN relating to the data objects in step s32 and using the location information accesses the inodes IN. It will be appreciated that the file system does not just read one inode IN, but might read multiple ones of the inodes IN to determine which ones are uncorrupted.

The inodes IN reveal from their attributes the object locators OL and this information is read in step s33 by the file system. It will be appreciated that the object locators OL will indicate the object streams DS allocated to one or more of the storage media M1 to Mn. The file system is able to retrieve in step s34 the data streams and, if required, collocate the data streams together in step s35 to form the semi-structured data object which is passed back through the API in step s36 to the user application.

It will be appreciated that one example of the user application is a database and that the memory storage system and method described herein is a powerful method of storing data objects which can be enlarged as required.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for the writing of semi-structured data objects into a memory system comprising:
transforming the semi-structured data object into a first data stream;
allocating a first storage area for the semi-structured data object in the memory system;
writing the first data stream to the allocated first storage area; and
creating at least one data object locator indicative of the commencement of the allocated first storage area; and
creating at least one inode indicative of the storage area of the first object locator.

2. The method of claim 1, further comprising:
updating the semi-structured data object;
allocating a second storage area for the updated semi-structured data object, wherein the second storage area is non-contiguous with the first storage area;
transforming the updated semi-structured data object into a second data stream;
writing the second data stream to the allocated second storage area;
updating the object locator and storing an updated object locator within a new storage area; and
updating the inode to reflect the new storage area of the updated object locator.

3. The method of claim 2, further comprising creating a version attribute associated with the updated semi-structured data object and being representative of a previous un-updated version of the updated semi-structured data object.

4. The method of claim 1, wherein the allocated first storage area is distributed as partial allocated first storage areas over one or more storage media of the memory system, and wherein the writing of the first data stream to the allocated first storage area comprises
splitting the first data stream into a plurality of partial data streams;
writing the plurality of partial data streams to the partial allocated first storage areas; and
wherein the data object locator is further indicative of the commencements of the partial allocated first storage areas.

5. The method of claim 4, further comprising:
writing a clone partial data stream to a partial allocated first storage area of the plurality of partial storage areas, the clone partial data stream being identical to a partial data stream of the plurality of partial data streams; and
entering an clone data stream attribute to the object locator, the cone data stream attribute indicating a presence of the clone partial data stream and the partial allocated first storage area to which the clone partial data stream has been written.

6. The method of claim 4, wherein at least one partial data stream of the plurality of partial data streams contains redundancy information allowing a future reconstruction of the semi-structured data object even in a case of data loss affecting a subset of the partial allocated first storage areas.

7. The method of claim 4, further comprising:
calculating a checksum of a checksum block of the first data stream, the checksum block being independent from the partial data streams;

8. The method of claim 1, further comprising:
allocating an auxiliary storage area for the semi-structured data object in the memory system;
writing an edition of the first data stream to the allocated auxiliary storage area; and
entering data to the object locator, the data indicating that the edition of the first data stream is available at the allocated auxiliary storage area.

9. The method of claim 1, further comprising:
filtering classified data in the semi-structured data object; and
allocating a classified storage area for at least the classified data in the memory system;
wherein the transforming of the semi-structured data object into a first data stream comprises:
transforming data of the semi-structured data object other than the classified data to an unclassified data stream;
transforming at least the classified data to a classified data stream; and
wherein the writing of the first data stream comprises:
writing the unclassified data stream to the allocated first storage area; and
writing the classified data stream to the classified storage area.

10. A method for the reading of semi-structured data objects from a memory system comprising:
reading an inode to obtain an object locator representative of the semi-structured data object to be read;
determining one or more storage areas in the memory system in which the semi-structured data object is stored;
reading one or more data streams from the one or more storage areas;
aggregating the one or data streams to a single data stream; and
transforming the single data stream to the semi-structured data object.

11. The method of claim 10, further comprising:
identifying from the object locator a previous version identifier, the previous version identifier being indicative of a previous version of the semi-structured data object;
determining one or more storage areas in the memory system in which the previous version of the semi-structured data object is stored;
reading one or more previous version data streams from the one or more storage areas;
aggregating the one or more previous version data streams to a single previous version data stream; and
transforming the single previous version data stream to the previous version of the semi-structured data object.

12. The method of claim 10, further comprising:
retrieving clone data stream data from the object locator, the clone data stream data indicating a presence of a clone data stream and the one or more storage areas of the clone data stream, wherein data within the clone data stream is identical to data of the one or more data streams;
reading the clone data stream from one or more storage areas indicated by the clone data stream data.

13. The method of claim 10, wherein at least one of the one or more data streams contains redundancy information, and wherein the method further comprises:
detecting a data loss, resulting in lost data, in a subset of the one or more data streams;
reconstructing the lost data using the redundancy information and/or parts of a clone data stream.

14. A data storage and retrieval device for a memory system comprising:
a plurality of memory devices;
a location table having a plurality of object locators indicative of semi-structured data objects stored on at least one of the plurality of memory devices;
a writing device adapted to accept at least one of the semi-structured data objects, identify a first storage area on one or more the plurality of memory devices and transform the semi-structured data objects to a data stream; and
a reading device adapted to access the location table to obtain a desired one of the plurality of object locators representative of a desired semi-structured data object and transform the data stream to the desired semi-structured data object.

15. The data storage and retrieval device of claim 14, wherein the location table is further adapted to allocate a second storage area for an updated semi-structured data object and to update the object locator in the location table such that the data object locator is indicative of a commencement of the allocated second storage area, and wherein the writing device is further adapted to accept the updated semi-structured data object, identify the allocated second storage area, and transform the updated semi-structured data object into a second data stream.

16. The data storage and retrieval device of claim 15, wherein the data object locator comprises a version attribute associated with the updated semi-structured data object and being representative of a previous un-updated version of the updated semi-structured data object.

17. The data storage and retrieval device of claim 14, wherein the first storage area is distributed as partial allocated first storage areas over one or more storage media of the memory system, wherein the writing device is further adapted to split the data stream into a plurality of partial data streams and to write the plurality of partial data streams to the partial allocated first storage areas, and wherein the object locator is further indicative of the commencement of the partial allocated first storage areas.

18. The data storage and retrieval device of claim 17, wherein at least one partial data stream of the plurality of partial data streams contains redundancy information allowing a future reconstruction of the semi-structured data object even in a case of data loss affecting a subset of the partial allocated first storage areas.

19. The data storage and retrieval device of claim 14, further comprising a data stream re-locator adapted to relocate existing data streams among the plurality of memory devices as a function of one or more predetermined criteria.

20. The data storage and retrieval device of claim 14 wherein the data object locator comprises an edition attribute associated with an edition of the semi-structured data object.
